(19) United States
(12) Patent Application Publication
(10) Pub. No.: US 2026/0191196 A1
(43) Pub. Date: Jul. 9, 2026

(54) COMPOSITIONS AND METHODS FOR IMPROVING SOIL MICROBIAL POPULATIONS

(71) Applicant: SYNGENTA CROP PROTECTION AG, Basel (CH)

(72) Inventors: Claudio SCREPANTI, Stein (CH); Alessandro BERGNA, Stein (CH); Ben OYSERMAN, Stein (CH); Francisco Javier PERIS FELIPO, Basel (CH)

(73) Assignee: SYNGENTA CROP PROTECTION AG, Basel (CH)

(21) Appl. No.: 19/132,266

(22) PCT Filed: Nov. 21, 2023
(86) PCT No.: PCT/EP2023/082559

§ 371 Date: May 22, 2025

(30) Foreign Application Priority Data
Nov. 24, 2022 (EP) 22209417.9

(51) Int. Cl. A01N 43/40; A01P 1/00; A01P 3/00; A01P 5/00

(52) U.S. Cl. CPC A01N 43/40; A01P 1/00; A01P 3/00; A01P 5/00

(57) ABSTRACT

A method of preserving or stimulating the growth of beneficial soil microbes in soil for crop or plant growth, comprising applying an effective amount of a composition comprising cyclobutrifluram to the plant, the locus, or propagation material thereof.

### BACKGROUND OF THE INVENTION

The present invention relates to the use of nematocidal compositions comprising 4-membered ring carboxamide compounds, in particular cyclobutylcarboxamide compounds and their use in improving soil microbiome compatibility for plants, in combination with, thereby promoting the growth of crops in the soil, enhance pest control, and/or facilitate soil bioremediation. The present invention also relates to methods for agricultural use of these compositions, which alter the soil microbiome in a manner that is beneficial to a plant, by promoting favourable microbial levels, microbial activity, microbial metabolism, and/or microbial diversity, the compositions described herein can be used to increase the usefulness of the soil microbiome for the plants.

Nematodes, also referred to as roundworms, constitute the phylum Nematoda, a diverse animal phylum inhabiting a broad range of environments, in particular moist surfaces and tissues.

Many nematodes have evolved into successful parasites of plants and animals, and are responsible for significant economic losses in particular in agriculture. Nematode parasites of plants can infest all parts of plants, including roots, developing flower buds, leaves, and stems. Accordingly, there is a need for safe and effective nematode controls in plants and/or in soil.

Nematicides have been widely used in agricultural systems as part of pest and/or weed control strategies. However, due to the intrinsic properties of these products, their use may induce an adverse impact to the soil microflora including bacteria, fungi, algae, and protozoa, and thereby also impact on their associated functions and critical roles involved with cycling of organic and inorganic nutrients within the soil. A reduction in the soil biodiversity, associated with the reduced interactions available between all soil organisms, is considered to reduce resistance of the soil to environmental changes, and thus lower its capacity to recover.

Consequently there remains an urgent need to develop environmentally safe, efficacious methods of controlling plant parasitic nematodes, while not affecting the soil microflora populations negatively. Also, it would be beneficial if growth of beneficial microflora, such as bacterial and fungal species could be supported. In particular there remains a need for nematicides with reduced secondary impact.

Cyclobutylcarboxamide compounds and processes for their preparation have been disclosed for instance in WO2013/143811 and WO2015/003951. A particularly effective cyclobutylcarboxamide compound, having the ISO name, cyclobutrifluram, is employed as a potent nematicide. The chemical structure of cyclobutrifluram is the compound of formula (I):

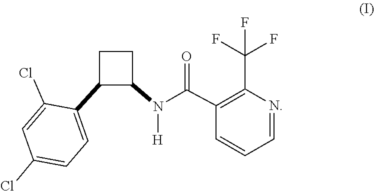 [SMILES: O=C(N[C@@H]1CC[C@@H]1c1ccc(Cl)cc1Cl)c1cccnc1C(F)(F)F]

Some activities of cyclobutrifluram, salts or N-oxides thereof, and close analogues thereof against root-knot nematodes such as Meloidogyne genus and cyst-forming nematodes such as Heterodera genus have been reported, as well as some fungicidal activities. However, it has now been surprisingly found that cyclobutrifluram is highly effective at controlling and improving the soil microbiome diversity, and health.

### BRIEF SUMMARY OF THE DISCLOSURE

Accordingly, in a first aspect, the present invention relates to a method of stimulating growth of beneficial soil microbes.

In a second aspect, the present invention relates to the method wherein stimulating growth of beneficial soil microbes comprises stimulating growth of bacterial and fungal species exhibiting biocontrol and/or soil remediation activity.

In a third aspect, the present invention relates to a method according to the invention, wherein beneficial microbes are selected from the group consisting of bacteria of the genus Sphingomonas, Bacillus, and Pseudomonas, and fungi of the genus Trichoderma.

In a fourth aspect the present invention relates to a method according to the invention, wherein cyclobutrifluram is applied onto a seed or propagation material in an amount of from between 1 gram and up to and including 1000 gram cyclobutrifluram per 100 kg seeds or propagation material, preferably, wherein cyclobutrifluram is applied onto the seed or propagation material in an amount of between 10 grams and 400 grams cyclobutrifluram per 100 kg seeds or propagation material; and yet more preferably wherein cyclobutrifluram is applied onto the seed or propagation material in an amount of between 20 grams and 100 grams cyclobutrifluram per 100 kg seeds or propagation material.

In a fifth aspect, the present invention relates to a method according to the invention, the composition is applied via drip irrigation, sprinkler irrigation, soil drenching or flood irrigation; in furrow application, or as a seed treatment.

In a sixth aspect, the present invention relates to a method according to the invention, the application of the composition is conducted prior to planting, or after planting.

In a seventh aspect, the present invention relates to a method according to the invention, the composition further comprises one or more additional biologically active agents, preferably one or more acaricide, bactericide, fungicide, insecticide, nematicide, and/or plant activator.

In an eight aspect, the present invention relates to the use of a composition comprising cyclobutrifluram for maintaining or improving soil microbiome integrity in a soil in need of treatment.

In a ninth aspect, the present invention relates to a method according to the invention, a soil in need of stimulation is selected by identifying a soil portion containing a plant pest present in an amount sufficient to harm or reduce the growth of a plant growing in the soil, preferably wherein the plant pests include plant parasitic nematodes, in particular endoparasitic-, semi-endoparasitic- and ectoparasitic nematodes.

In a tenth aspect, the present invention relates to the use of a composition comprising cyclobutrifluram for improving plant wellness of plants growing in a soil in need of treatment.

### BRIEF DESCRIPTION OF THE DRAWINGS

FIG. 1 shows the extent of the development of fungal microbial community modifications in the soil microbiome associated with the cyclobutrifluram treatment. Differential abundance of fungal taxa after 97 days in treated soil, as detected by PCR amplification and successive high-throughput sequencing of fungal taxonomical marker genes (the small-subunit ribosomal RNA gene (16S) and the ribosomal internal transcribed spacers (ITS) respectively) on plant-associated soil samples.

FIG. 2 depicts variation of Shannon-Wiener biodiversity index for bacteria (16S) and fungi (ITS) communities through the time (T0, T1, T2 and T3) at locations of FIG. 2.

FIG. 3 depicts differentially abundant beneficial Bacteria taxa (DA) found in four different treatments of potato plants in a field trial, when compared to the control condition at different time points. Different letters indicate locations (A) and (B). Different shapes indicate different treatments: Comparative example Fluopyram in squares, Cyclobutrifluram according to the present invention, in two different concentrations: triangle (A′200) and diamond (A″250). The size of the respective symbol indicates the significance degree (p-value), with a larger size being more significant, the lowest size not significance of the observed fold change for a taxon. Gradient scale ranges from dark grey (negative values) to light grey (positive values).

FIG. 4 depicts differentially beneficial Fungi found in the four different treatments of potato plants in a field trial. Again, different letters indicate locations (A) and (B). Different shapes indicate different treatments: Comparative example Fluopyram in squares, Cyclobutrifluram according to the present invention, in two different concentrations: triangle (A′200) and diamond (A″250). The size of the respective symbol indicates the significance degree (p-value), with a larger size being more significant, the lowest size not significance of the observed fold change for a taxon. Gradient scale ranges from dark grey (negative values) to light grey (positive values).

### DETAILED DESCRIPTION OF THE INVENTION

The compositions according to the invention can advantageously be used for controlling or destroying pests such as insects and/or fungi which occur in particular on plants, especially on useful plants and ornamentals in agriculture, in horticulture and in forests, or on organs, such as fruits, flowers, foliage, stalks, tubers, seeds or roots, of such plants, and in some cases even plant organs which are formed at a later point in time remain protected against these pests.

It is known that soil with a healthy microorganism population is best suited for effective pest control, robust plant growth, and efficient biodegradation of unwanted soil contaminants. Soil microorganisms break down dead plant and animal material and mediate the biodegradation of most man-made pesticides. To thrive, these microorganisms require a readily available source of carbon for food. Furthermore, it is more desirable to stimulate the proliferation of indigenous soil microorganisms than to add microorganisms from an external source.

The compounds of formula (I) according to the invention are preventively and/or curatively valuable active ingredients in the field of pest control, even at low rates of application, which can be used against pesticide resistant pests such as insects and fungi, which compounds of formula (I) have a very favourable biocidal spectrum and are well tolerated by warm-blooded species, fish and plants.

It has now been found that the compounds of formula I according to the invention have, for practical purposes, a very advantageous spectrum of activities for protecting pants and soil microbiome health, and are therefore particularly useful for protecting plants against attack and damage by nematodes, and for increasing plant and soil health.

Accordingly, the present invention also makes available a composition comprising compounds of the invention of formula (I), for improving the soil microbiome.

It has also now been found that the compounds of formula I according to the invention have, for practical purposes, a very advantageous spectrum of activities for protecting useful plants against attack and damage by fungi. Accordingly, the present invention also makes available a fungicidal composition comprising compounds of the invention, such as formula (I).

Cyclobutrifluram as disclosed above represents the cis racemate: the phenyl ring on the left-hand side and the pyridyl-C(═O)—NH group on the right-hand side are cis to each other on the cyclobutyl ring as illustrated for compound of formula (Ia) and (Ib):

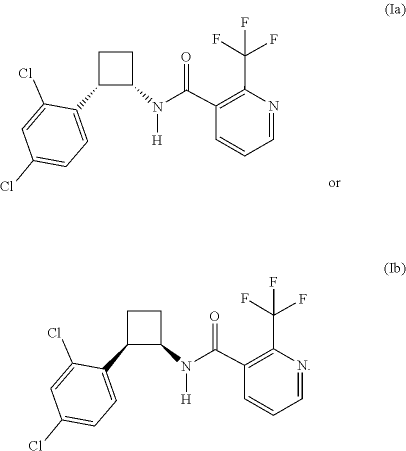 [SMILES: O=C(N[C@H]1CC[C@H]1c1ccc(Cl)cc1Cl)c1cccnc1C(F)(F)F ; O=C(N[C@@H]1CC[C@@H]1c1ccc(Cl)cc1Cl)c1cccnc1C(F)(F)F]

The racemic compound of cyclobutrifluram is a 1:1 mixture of the compounds of formula (Ia) and (Ib). The wedged bonds shown in the compounds of formula (Ia) and (Ib) represent absolute stereochemistry, whereas the thick straight bonds such as those shown for compound of formula (I) represent relative stereochemistry in racemic compounds. It has also surprisingly been found that one enantiomer of cyclobutrifluram is particularly useful in a method for controlling or preventing infestation of plants by a phytopathogenic microorganism of the genus Aspergillus.

Thus, preferably, there is provided the method according to the invention wherein cyclobutrifluram is in the form of the (1S, 2S) stereoisomer (la):

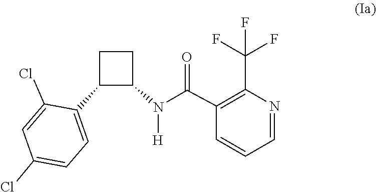 [SMILES: O=C(N[C@H]1CC[C@H]1c1ccc(Cl)cc1Cl)c1cccnc1C(F)(F)F]

A skilled person is aware that according to the method of the invention, cyclobutrifluram is generally applied as part of a pesticidal composition, whereby it is known that the compounds of formula (I) are especially useful for the control of nematodes. Hence there is provided a method for controlling or preventing infestation of plants by a nematode plant pest comprising applying to a crop of plants, the locus thereof, or propagation material thereof a pesticidal composition comprising cyclobutrifluram and one or more formulation adjuvants, simultaneously with improving the soil microbiome according to the invention. The preparation of cyclobutrifluram has been disclosed in WO2013/143811 and WO2015/003951 which are incorporated herein by reference.

Crop or plant health is closely associated with the balance of beneficial microbial species in a soil, whereby chiefly soil type, soil fertility, moisture, competing microbes, and plants interact in a complex manner. The interplay between microbial species and plants is further affected by agricultural practices, which can improve or degrade the soil microbiome. Fertile or highly productive soils hence may contain a different composition of native microbes than soil that is depleted of nutrients and linked to low crop productivity.

Different microbial species are associated closely with plants, on the above ground plant surfaces in the phyllosphere, at the root surface in the soil rhizosphere, or intimately as endophytes.

Large-scale DNA analysis of these microbe associations has revealed unexpected phylogenetic complexity, and it has been postulated that complex microbiomes can be correlated to plant health, stress tolerance, secondary metabolite accumulation, and disease tolerance.

Furthermore, plants specifically select the microbial communities from the local environment, and fine-tune the microbiome at the level of crop variety. Root-associated microbes can promote plant and root growth by promoting nutrient cycling and acquisition, by direct phytostimulation, by mediating biofertilization, or by offering growth advantage through biocontrol of pathogens.

Agriculturally useful populations of beneficial microbes include plant growth promoting rhizobacteria (PGPR), pathogen-suppressive bacteria, mycorrhizae, nitrogen-fixing bacteria, stress tolerance endophytes, as well as other microbes with a range of biodegradative capabilities. Microbes involved in nitrogen cycling include the nitrogen-fixing Azotobacter and Bradyrhizobium genera, nitrogen-fixing cyanobacteria, ammonia-oxidizing bacteria, such as for instance the genera Nitrosomonas and Nitrospira; nitrite-oxidizing genera such as Nitrospira and Nitrobacter, and heterotropic-denitrifying bacteria, in particular of the Pseudomonas and Azospirillum genera.

Bacterial genera considered as active in solubilization and increasing plant access to phosphorus include the Pseudomonas, Bacillus, Micrococcus, and Flavobacterium, as well as various fungal genera, in particular of the genera Trichoderma. Bacillus and Clostridium species help solubilize and mobilize potassium.

Phytostimulation of plant growth and relief of biotic and abiotic stresses is delivered by numerous bacterial and fungal associations, directly through the production of stimulatory secondary metabolites or indirectly by triggering low-level plant defense responses.

Applicants found that cyclobutrifluram may, among others, enhance the growth of beneficial microbes comprising bacteria of the genus Sphingomonas, Bacillus, and/or Pseudomonas, as well as fungi of the genus Trichoderma. The genus Sphingomonas, such as S. sediminicola, S. japsi and S. daechungensis has been related widely with bioremediation and fungicide properties. The genus Bacillus, such as Bacillus halmapalus and B. cereus has been related with several beneficial functions in the soil and for the plant's health, as phytohormone production, pathogens protection and abiotic stress protection.

Beneficially, this growth enhancement may be done simultaneously or subsequently, in combination with a method of controlling damage to plant and parts thereof by plant parasitic nematodes, in particular Endoparasitic-, Semiendoparasitic- and Ectoparasitic nematodes, especially plant parasitic nematodes such as root knot nematodes, Meloidogyne hapla, Meloidogyne incognita, Meloidogyne javanica, Meloidogyne arenaria and other Meloidogyne species; cyst-forming nematodes, Globodera rostochiensis and other Globodera species; Heterodera avenae, Heterodera glycines, Heterodera schachtii, Heterodera trifolii, and other Heterodera species; Seed gall nematodes, Anguina species; Stem and foliar nematodes, Aphelenchoides species; Sting nematodes, Eelonolaimus longicaudatus and other Belonolaimus species; Pine nematodes, Bursaphelenchus xylophilus and other Bursaphelenchus species; Ring nematodes, Criconema species, Criconemella species, Criconemoides species, Mesocriconema species; Stem and bulb nematodes, Ditylenchus destructor, Ditylenchus dipsaci and other Ditylenchus species; Awl nematodes, Dolichodorus species; Spiral nematodes, Heliocotylenchus multicinctus and other Helicotylenchus species; Sheath and sheathoid nematodes, Hemicycliophora species and Hemicriconemoides species; Hirshmanniella species; Lance nematodes, Hoploaimus species; false rootknot nematodes, Nacobbus species; Needle nematodes, Longidorus elongatus and other Longidorus species; Pin nematodes, Pratylenchus species; Lesion nematodes, Pratylenchus neglectus, Pratylenchus penetrans, Pratylenchus curvitatus, Pratylenchus goodeyi and other Pratylenchus species; Burrowing nematodes, Radopholus similis and other Radopholus species; Reniform nematodes, Rotylenchus robustus, Rotylenchus reniformis and other Rotylenchus species; Scutellonema species; Stubby root nematodes, Trichodorus primitivus and other Trichodorus species, Paratrichodorus species; Stunt nematodes, Tylenchorhynchus claytoni, Tylenchorhynchus dubius and other Tylenchorhynchus species; Citrus nematodes, Tylenchulus species; Dagger nematodes, Xiphinema species; and other plant parasitic nematode species, such as Subanguina spp., Hypsoperine spp., Macroposthonia spp., Melinius spp., Punctodera spp., and Quinisulcius spp. It is noted that where the term “species” is used herein above, it may comprise one or more species; as usually abbreviated by the term “spp.”.

The term “microbe” herein relates to a microorganism, including but not limited to bacteria, archaebacteria, fungi, and algae, such as microalgae. In some examples, microbes are single-cellular organisms, for instance bacteria, cyanobacteria, some fungi, or some algae. In other examples, the term microbes includes multi-cellular organisms, such as certain fungi or algae, for instance multi-cellular filamentous fungi or multicellular algae.

The Term “preserving or improving the soil microbiome” relates to the composition of the soil microbiome, wherein both presence of useful microbes is either maintained, or improved, whereas plant pathogenic microbes are either preserved or reduced. This implies that the soil biodiversity is preserved or improved to preserve a vibrant range of life forms in the soil and enable plants to develop bigger root systems in infested farmlands.

In a method according to the invention, for beneficial compositions comprising both the (1S,2S) and (1R,2R) stereoisomers of cyclobutrifluram, the ratio of the (1S,2S) stereoisomer to its enantiomer (1R,2R) is preferably greater than 1:1. More preferably, the ratio of the (18,2S) to (1S,2S) is greater than 1.5:1, more preferably greater than 2.5:1, especially greater than 4:1, advantageously greater than 9:1, desirably greater than 20:1, in particular greater than 35:1.

Mixtures containing up to 50%, preferably up to 40%, more preferably up to 30%, especially up to 20%, advantageously up to 10%, desirably up to 5%, in particular up to 3%, of the trans stereoisomers of the compounds of formula (I) (i.e. wherein the phenyl and the pyridyl-C(═O)—NH groups are trans to each other) are also understood to be part of this invention. Preferably, the ratio of the cis isomer to its trans isomer is greater than 1.5:1, more preferably greater than 2.5:1, especially greater than 4:1, advantageously greater than 9:1, desirably greater than 20:1, in particular greater than 35:1.

According to a further embodiment of the invention, there is provided a method, wherein the composition is a suspension concentrate composition. According to a further embodiment of the invention, there is provided a method for the use of the composition, comprising the steps of: providing cyclobutrifluram or a composition comprising cyclobutrifluram as defined in any one of embodiments herein above; and applying the composition to a propagation material; and planting of the propagation material into a medium, preferably a soil portion.

According to a further embodiment of the invention, there is provided a method for the use of the composition, comprising the steps of: providing cyclobutrifluram or a composition comprising cyclobutrifluram as defined in any one of embodiments herein above; and applying the composition to a plant, propagation material, or the locus thereof.

According to a further embodiment of the invention, there is provided a method for growing a plant comprising applying or treating a propagation material thereof with cyclobutrifluram or a composition comprising cyclobutrifluram as defined herein above, for the simultaneous or subsequent enhancement of beneficial microbial activity in the surrounding soil.

According to a further embodiment of the invention there is provided a method of selectively reducing fusarium populations in soil, for example by at least 50%, preferably by at least 80%, while leaving the level of arbuscular mycorrhizal fungi largely unchanged, for example reduced by no more than 20%, preferably by no more than 10%, the method comprising applying or treating the soil with cyclobutrifluram or a composition comprising cyclobutrifluram as defined herein.

It has also been found that cyclobutrifluram can have a synergistic effect in promoting plant growth and/or plant health in combination with arbuscular mycorrhizal fungi. Such fungi can be those already present naturally in the soil, or can be additional arbuscular mycorrhizal fungi added to soil separately or simultaneously with the cyclobutrifluram.

Preferably, the propagation material is a seed. More preferably, cyclobutrifluram is applied onto the seed in an amount of between 1 gram and 1000 grams cyclobutrifluram per 100 kg seeds. Yet more preferably, cyclobutrifluram is applied onto the seed in an amount of between 10 grams and 400 grams of cyclobutrifluram per 100 kg seeds, yet again more preferably wherein cyclobutrifluram is applied onto the seed in an amount of between 20 grams and 100 grams of cyclobutrifluram per 100 kg seeds. Preferably, the method provided herein may be applied to useful plants. The application of the compounds of the present invention to seeds is a preferred application method. The term “seed” embraces seeds, plant propagation material and plant propagules of all kinds including but not limited to true seeds, seed pieces, suckers, corns, bulbs, fruit, tubers, grains, rhizomes, cuttings, cut shoots and the like and means in a preferred embodiment true seeds.

Application according to the methods or uses according to the invention is preferably done to a crop or a plant, the locus thereof or propagation material thereof. Preferably application is to a plant or propagation material thereof, more preferably to propagation material.

Application of cyclobutrifluram or a pesticidal composition comprising cyclobutrifluram may advantageously be performed according to any of the usual modes of application, e.g., foliar, drench, soil, in furrow or the like. Applicants found that due to the beneficial effect of the composition on soil microbiome composition over time, plant health could be significantly increased.

The methods as defined in herein above are suitable for use on any plant, including those that have been genetically modified to be resistant to active ingredients such as herbicides, or to produce biologically active compounds that control infestation by plant pests.

Generally, cyclobutrifluram may be used in the form of a composition (e.g. formulation) containing a carrier. Cyclobutrifluram and compositions comprising cyclobutrifluram as defined in any one of embodiments herein above may be used in various forms such as aerosol dispenser, capsule suspension, cold fogging concentrate, dustable powder, emulsifiable concentrate, emulsion oil in water, emulsion water in oil, encapsulated granule, fine granule, flowable concentrate for seed treatment, gas (under pressure), gas generating product, granule, hot fogging concentrate, macrogranule, microgranule, oil dispersible powder, oil miscible flowable concentrate, oil miscible liquid, paste, plant rodlet, powder for dry seed treatment, seed coated with a pesticide, soluble concentrate, soluble powder, solution for seed treatment, suspension concentrate (flowable concentrate), ultra low volume (ulv) liquid, ultra low volume (ulv) suspension, water dispersible granules or tablets, water dispersible powder for slurry treatment, water soluble granules or tablets, water soluble powder for seed treatment and wettable powder.

A formulation typically comprises a liquid or solid carrier and optionally one or more customary formulation auxiliaries, which may be solid or liquid auxiliaries, for example unepoxidized or epoxidized vegetable oils, for example epoxidized coconut oil, rapeseed oil or soya oil; antifoaming agents, for example silicone oil, preservatives, clays, inorganic compounds, viscosity regulators, surfactant, binders and/or tackifiers.

The composition may also further comprise a fertilizer, a micronutrient donor or other preparations which influence the growth of plants as well as comprising a combination containing the compound of the invention with one or more other biologically active agents, such as bactericides, fungicides, nematicides, plant activators, acaricides, and insecticides.

The compositions are prepared in a manner known per se, in the absence of auxiliaries for example by grinding, screening and/or compressing a solid compound of the present invention and in the presence of at least one auxiliary for example by intimately mixing and/or grinding the compound of the present invention with the auxiliary or auxiliaries. In the case of solid compounds of the invention, the grinding/milling of the compounds is to ensure specific particle size.

Examples of compositions for use in agriculture are emulsifiable concentrates, suspension concentrates, microemulsions, oil dispersibles, directly sprayable or dilutable solutions, spreadable pastes, dilute emulsions, soluble powders, dispersible powders, wettable powders, dusts, granules or encapsulations in polymeric substances, which comprise—at least—cyclobutrifluram and the type of composition is to be selected to suit the intended aims and the prevailing circumstances.

As a rule, the compositions comprise 0.1 to 99%, especially 0.1 to 95%, of cyclobutrifluram and 1 to 99.9%, especially 5 to 99.9%, of at least one solid or liquid carrier, it being possible as a rule for 0 to 25%, especially 0.1 to 20%, of the composition to be surfactants, % in each case meaning percent by weight.

While concentrated compositions tend to be preferred for commercial goods due to the lower volumes and inherent higher stability in the absence of water, the end user—as a rule—uses dilute compositions which have substantially lower concentrations of active ingredient. Examples of foliar formulation types for pre-mix compositions are: GR: Granules; WP: wettable powders; WG: water dispersible granules (powders); SG: water soluble granules; SL: soluble concentrates; EC: emulsifiable concentrate; EW: emulsions, oil in water; ME: micro-emulsion; SC: aqueous suspension concentrate; CS: aqueous capsule suspension; OD: oil-based suspension concentrate, and SE: aqueous suspo-emulsion.

Examples of seed treatment formulation types for pre-mix compositions are: WS: wettable powders for seed treatment; slurry LS: solution for seed treatment; ES: emulsions for seed treatment; FS: suspension concentrate for seed treatment; WG: water dispersible granules, and CS: aqueous capsule suspension. Examples of formulation types suitable for tank-mix compositions are solutions, dilute emulsions, suspensions, or a mixture thereof, and dusts.

As with the nature of the formulations, the methods of application, such as foliar, drench, spraying, atomizing, dusting, scattering, coating or pouring, are chosen in accordance with the intended objectives and the prevailing circumstances.

The tank-mix compositions are generally prepared by diluting with a solvent (for example, water) the one or more pre-mix compositions containing different pesticides, and optionally further auxiliaries.

Suitable carriers and adjuvants can be solid or liquid and are the substances ordinarily employed in formulation technology, e.g. natural or regenerated mineral substances, solvents, dispersants, wetting agents, tackifiers, thickeners, binders or fertilizers.

Generally, a tank-mix formulation for foliar or soil application comprises 0.1 to 20%, especially 0.1 to 15%, of the desired ingredients, and 99.9 to 80%, especially 99.9 to 85%, of a solid or liquid auxiliaries, including, for example, a solvent such as water, where the auxiliaries can be a surfactant in an amount of 0 to 20%, especially 0.1 to 15%, based on the tank-mix formulation.

Typically, a pre-mix formulation for foliar application comprises 0.1 to 99.9%, especially 1 to 95%, of the desired ingredients, and 99.9 to 0.1%, especially 99 to 5%, of a solid or liquid adjuvant (including, for example, a solvent such as water), where the auxiliaries can be a surfactant in an amount of 0 to 50%, especially 0.5 to 40%, based on the pre-mix formulation.

Normally, a tank-mix formulation for seed treatment application comprises 0.25 to 80%, especially 1 to 75%, of the desired ingredients, and 99.75 to 20%, especially 99 to 25%, of a solid or liquid auxiliaries, including, for example, a solvent such as water, where the auxiliaries can be a surfactant in an amount of 0 to 40%, especially 0.5 to 30%, based on the tank-mix formulation.

Typically, a pre-mix formulation for seed treatment application comprises 0.5 to 99.9%, especially 1 to 95%, of the desired ingredients, and 99.5 to 0.1%, especially 99 to 5%, of a solid or liquid adjuvant, including, for example, a solvent such as water, where the auxiliaries can be a surfactant in an amount of 0 to 50%, especially 0.5 to 40%, based on the pre-mix formulation.

Whereas commercial products will preferably be formulated as concentrates, namely pre-mix compositions or formulations, the end user will normally employ dilute formulations, such as so-called tank mix compositions.

Preferred seed treatment pre-mix formulations are aqueous suspension concentrates. The formulation can be applied to the seeds using conventional treating techniques and machines, such as fluidized bed techniques, the roller mill method, rotostatic seed treaters, and drum coaters. Other methods, such as spouted beds may also be useful. The seeds may be presized before coating. After coating, the seeds are typically dried and then transferred to a sizing machine for sizing. Such procedures are known in the art. Cyclobutrifluram is particularly suited for use in soil and seed treatment applications.

Whereas commercial products will preferably be formulated as concentrates (e.g., pre-mix composition (formulation)), the end user will normally employ dilute formulations (e.g., tank mix composition).

Preferred seed treatment pre-mix formulations are aqueous suspension concentrates. The formulation can be applied to the seeds using conventional treating techniques and machines, such as fluidized bed techniques, the roller mill method, rotostatic seed treaters, and drum coaters. Other methods, such as spouted beds may also be useful. The seeds may be presized before coating. After coating, the seeds are typically dried and then transferred to a sizing machine for sizing. Such procedures are known in the art. The compounds of the present invention are particularly suited for use in soil and seed treatment applications.

In general, the pre-mix compositions of the invention contain 0.5 to 99.9 especially 1 to 95, advantageously 1 to 50, %, by mass of the desired ingredients, and 99.5 to 0.1, especially 99 to 5, %, by mass of a solid or liquid adjuvant (including, for example, a solvent such as water), where the auxiliaries (or adjuvant) can be a surfactant in an amount of 0 to 50, especially 0.5 to 40, %, by mass based on the mass of the pre-mix formulation.

A compound of the formula (I) in a preferred embodiment, independent of any other embodiments, is in the form of a plant propagation material treating (or protecting) composition, wherein said plant propagation material protecting composition may comprises additionally a colouring agent. The plant propagation material protecting composition or mixture may also comprise at least one polymer from water-soluble and water-dispersible film-forming polymers that improve the adherence of the active ingredients to the treated plant propagation material, which polymer generally has an average molecular weight of at least 10,000 to about 100,000.

Examples of application methods for the compounds of the invention and compositions thereof, that is the methods of controlling pests in the agriculture, are spraying, atomizing, dusting, brushing on, dressing, scattering or pouring-which are to be selected to suit the intended aims of the prevailing circumstances.

One method of application in agriculture is application to the foliage of the plants (foliar application), it being possible to select frequency and rate of application to match the danger of infestation with the pest/fungi in question. Alternatively, the active ingredient can reach the plants via the root system (systemic action), by applying the compound to the locus of the plants, for example by application of a liquid composition of the compound into the soil (by drenching), or by applying a solid form of the compound in the form of granules to the soil (soil application). In the case of paddy rice plants, such granules can be metered into the flooded paddy-field. The application of the compounds of the present invention to the soil is a preferred application method.

Typical rates of application per hectare is generally of from 10 to 500 g of active ingredient per hectare, in particular 50 to 250 g/ha, preferably 100 to 250 g/ha, such as 150 to 200 g/ha.

The compounds of the invention and compositions thereof are also suitable for the protection of plant propagation material, for example seeds, such as fruit, tubers or kernels, or nursery plants, against pests of the abovementioned type. The propagation material can be treated with the compound prior to planting, for example seed can be treated prior to sowing. Alternatively, the compound can be applied to seed kernels (coating), either by soaking the kernels in a liquid composition or by applying a layer of a solid composition. It is also possible to apply the compositions when the propagation material is planted to the site of application, for example into the seed furrow during drilling. These treatment methods for plant propagation material and the plant propagation material thus treated are further subjects of the invention.

The method according to the invention can be used for controlling, i. e. containing or destroying, pests of the abovementioned type which occur in particular on plants, especially on useful plants and ornamentals in agriculture, in horticulture and in forests, or on organs, such as fruits, flowers, foliage, stalks, tubers or roots, of such plants, and in some cases even plant organs which are formed at a later point in time remain protected against these pests. Suitable target crops are, in particular, cereals, such as wheat, barley, rye, oats, rice, maize or sorghum; beet, such as sugar or fodder beet; fruit, for example pomaceous fruit, stone fruit or soft fruit, such as apples, pears, plums, peaches, almonds, cherries or berries, for example strawberries, raspberries or blackberries; leguminous crops, such as beans, lentils, peas or soya; oil crops, such as oilseed rape, mustard, poppies, olives, sunflowers, coconut, castor, cocoa or ground nuts; cucurbits, such as pumpkins, cucumbers or melons; fibre plants, such as cotton, flax, hemp or jute; citrus fruit, such as oranges, lemons, grapefruit or tangerines; vegetables, such as spinach, lettuce, asparagus, cabbages, carrots, onions, tomatoes, potatoes or bell peppers; Lauraceae, such as avocado, Cinnamonium or camphor; and also tobacco, nuts, coffee, eggplants, sugarcane, tea, pepper, grapevines, hops, the plantain family and latex plants. The methods of the present invention may be also used on any ornamental and/or vegetable crops, including flowers, shrubs, broad-leaved trees and evergreens.

The invention will now be illustrated by the following non-limiting Examples. All citations are incorporated by reference.

### Biological Examples

Although methods and materials similar or equivalent to those described herein can be used to practice or test the disclosed technology, suitable methods and materials are described below. The materials, methods, and examples are illustrative only and not intended to be limiting.

### Plant Associated Soil Microbiome

To detect microbial community modifications in the soil microbiome associated with the cyclobutrifluram treatment against root knot nematodes, PCR amplification and successive high-throughput sequencing of bacterial and fungal taxonomical marker genes (the small-subunit ribosomal RNA gene (16S) and the ribosomal internal transcribed spacers (ITS) respectively) were performed on plant-associated soil samples.

In general, differential abundance analysis of microbiome data detected no significant modifications in the bacterial community at genus level in connection with Cyclobutrifluram treatment. At ASV level, no ecologically relevant ASVs (relative abundance >1%, Table 3a) were found significantly following cyclobutrifluram treatment. The 14 ASVs found to be significantly changing are characterised by a relative abundance <0.1% and therefore of minor ecological relevance.

### Bacterial Community

It was found that no modifications of in the bacterial diversity were detected. Bacterial ASVs were detected by 16SrRNA gene amplicon sequencing with taxonomy assignment at ASV level. The relative abundance in Control and Cyclobutrifluram treated samples and, when statistically significative (Deseq2, p=0.1), the relative abundance variation is reported in Table 1a, reporting bacterial ASVs detected by 16S rRNA gene amplicon sequencing with taxonomy assignment at ASV level. Here is reported the relative abundance in Control and Cyclobutrifluram treated samples and, when statistically significative (Deseq2, p=0.1), the relative abundance variation. Shown are the bacteria with an abundance of above 0.01%.

TABLE 1a
Table reporting bacterial ASVs
Bacterial Community

| | | | Lowest | |
|---|---|---|---|---|
| | | | assigned | |
| | Relative abundance | | taxono- | |
| Taxon | Control | Cyclobutrifluram | mical rank | • |
| Acidobacteria-6 | 0.000% | 0.050% | Class | +0.050% |
| Gem- | 0.000% | 0.071% | Class | +0.071% |
| matimonadetes | | | | |
| Strepto- | 0.000% | 0.020% | Family | +0.020% |
| sporangiaceae | | | | |
| Myxococcales | 0.000% | 0.033% | Order | +0.033% |
| Rhizobiales | 0.000% | 0.025% | Order | +0.025% |
| Acidobacteria-6 | 0.000% | 0.051% | Class | +0.051% |
| PK29 | 0.000% | 0.021% | Order | +0.021% |
| Acidobacteria-6 | 0.000% | 0.027% | Class | +0.027% |
| Acidobacteria-6 | 0.000% | 0.028% | Class | +0.028% |
| Planctomyces | 0.000% | 0.016% | Genus | +0.016% |
| Gaiella | 0.000% | 0.065% | Genus | +0.065% |
| Acidobacteria-6 | 0.012% | 0.084% | Class | +0.071% |
| Microlunatus | 0.000% | 0.032% | Genus | +0.032% |
| Acidobacteria-6 | 0.000% | 0.030% | Class | +0.030% |

### Fungal Community

Comparison of the fungal community of Control and RKN-Cyclobutrifluram plant-associated 5 soil samples highlighted a microbiome shift mainly characterised by the reduction of the plant-pathogen Fusarium, an ubiquitous pathogenic fungus that constitutes an abundant taxon in control soil. Fusarium relative abundance results reduced from 17.8% in control samples to 7.5% after cyclobutrifluram treatment. Moreover, the variation of other ecologically relevant taxa, as shown in Table 1b, is low. Table 1b reports fungal genera detected by ITS gene amplicon sequencing with taxonomy assignment at genus level; relative abundance in Control and Cyclobutrifluram treated samples statistically significative (Deseq2, p=0.1), the relative abundance variation.

TABLE 1b
Fungal Community

| | Relative abundance | | |
|---|---|---|---|
| Fungal genus | Control | Cyclobutrifluram | • |
| Fusarium | 17.818% | 7.544% | −10.274% |
| Chrysosporium | 14.409% | 17.327% | +2.918% |
| Cladosporium | 5.932% | 3.983% | −1.949% |
| Mortierella | 2.523% | 2.111% | −0.412% |
| Endoconidiophora | 2.521% | 5.102% | +2.581% |
| Mycosphaerella | 2.213% | 1.672% | −0.541% |
| Candida | 1.108% | 0.839% | −0.269% |
| Saitozyma | 0.946% | 0.907% | −0.038% |
| Pseudaleuria | 0.756% | 1.936% | +1.181% |
| Conostachys | 0.666% | 0.797% | +0.132% |
| Verticillium | 0.415% | 0.571% | +0.156% |
| Phialemonium | 0.402% | 0.357% | −0.044% |
| Solicoccozyma | 0.325% | 0.407% | +0.082% |
| Pseudogymnoascus | 0.319% | 0.870% | +0.550% |
| Oidiodendron | 0.238% | 0.292% | +0.054% |
| Tetracladium | 0.231% | 0.318% | +0.088% |
| Acremonium | 0.158% | 0.214% | +0.056% |
| Lectera | 0.151% | 1.767% | +1.617% |
| Humicola | 0.112% | 0.000% | −0.112% |
| Eleutherascus | 0.108% | 0.217% | +0.108% |
| Sebacina | 0.104% | 0.077% | −0.027% |
| Arthrinium | 0.104% | 0.398% | +0.293% |
| Paraphoma | 0.067% | 0.043% | −0.023% |
| Schwanniomyces | 0.022% | 0.017% | −0.005% |
| Monocillium | 0.013% | 0.083% | +0.070% |

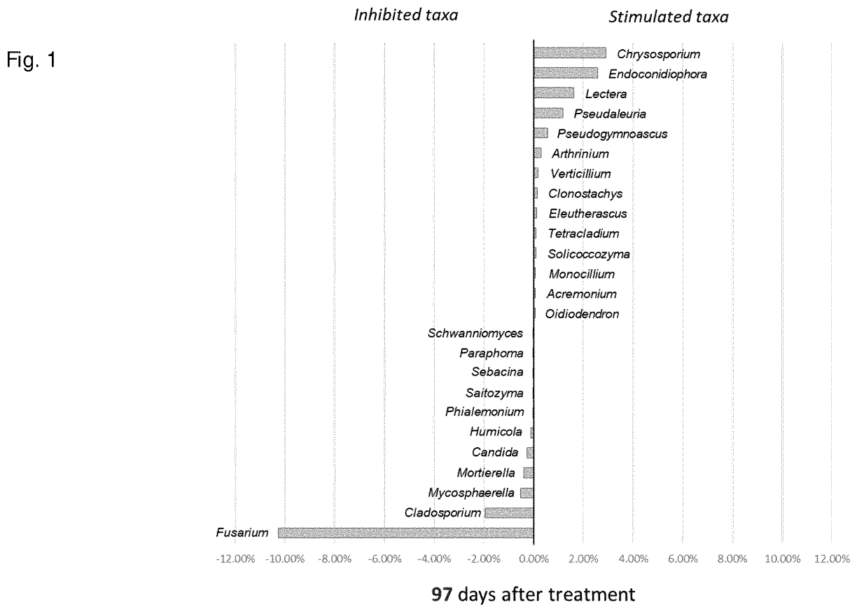

FIG. 1 shows the extent of the impact on various fungal taxa in direct comparison, both stimulated as well as inhibited. Surprisingly, Cyclobutrifluram treatment preserves soil microbiome diversity apart from inhibiting Fusarium, as the very negligible inhibiting or the stimulating effects to the other species have very low or no impacts from a microbial ecological perspective.

Cyclobutrifluram Impact on Microbial Populations within the Soil-Field Trial

In this experiment, assuming that biodiversity can be measured by the taxonomic richness and abundance of each taxon, the differences between treatments are determined and their effect on populations and beneficial species over time is verified. This leads to testing two hypotheses. Firstly, there is an impact of cyclobutrifluram applications on microbial diversity. Secondly, the use of cyclobutrifluram improves beneficial microbial diversity over time. These hypotheses were tested in two potato farms in the USA.

The experiment was carried out in two potato (Solanum tuberculosum L.) fields located in two test locations in Louisiana, USA, described as locations A and B in Table 2. In each experimental field, three products were tested in an area of 10 m² (Table 3) and three replicates per product were established by complete block randomized. To evaluate the effects on the microbiome a “Check” plot (untreated) was established. In addition, fluopyram was employed as a comparative example. Fluopyram is a widely used fungicide and nematicide, and represents the industry standard herein. The application method was inoculation of a slurry, in the concentrations given in Table 3.

TABLE 2
Trial location

| Trial Location | Crop - Variety |
|---|---|
| A, Louisiana | Potato - Red LaSoda |
| B, Louisiana | Potato - Red LaSoda |

TABLE 3
Treatment list

| Treatment | | Al Rate |
|---|---|---|
| 1 | Control | — |
| 2 | Cyclobutrifluram | 200 gai/ha |
| 3 | Cyclobutrifluram | 250 gai/ha |
| 4 | FLUOPYRAM (Comparative | 250 gai/ha |
| | Example) | |

To analyse the microbial biodiversity, three soil samples were taken per treatment and each sample consisted of soil collected from three different points within the plots. In this way, the effect of soil variability was minimized, since there were nine samples per treatment.

Soil samples were collected four times (T) during the cropping season to understand the effect of treatments on the microbiome over time, wherein TO represents the time before the treatment application, T1 represents 30 days after treatment, T2 represents 60 days after treatment and T3 represents 120 days after treatment.

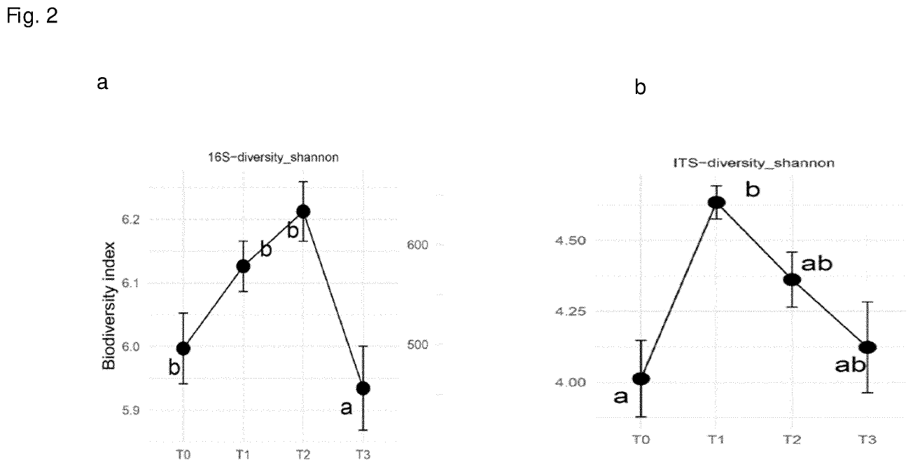

As set out above, to detect microbial community modifications in the soil microbiome associated with the cyclobutrifluram treatment, PCR amplification and successive high-throughput sequencing of bacterial and fungal taxonomical marker genes (the small-subunit ribosomal RNA gene (16S) and the ribosomal internal transcribed spacers (ITS) respectively) were performed on plant-associated soil samples. An exploratory data analysis was conducted to describe the microbial biodiversity and the behaviour of the percentage of the abundance of species under the evaluated factors. 16Sand Internal Transcribed Spacer (ITS) ribosomal RNA (rRNA) sequencing are common amplicon sequencing methods used to identify and compare bacteria or fungi present within a given sample, taken at a given time and location. This is also expressed in graph depicting the Shannon-Wiener biodiversity index for bacteria (16S) and fungi (ITS) communities through the times (T0, T1, T2 and T3), as depicted in FIG. 2.

### Beneficial Bacteria

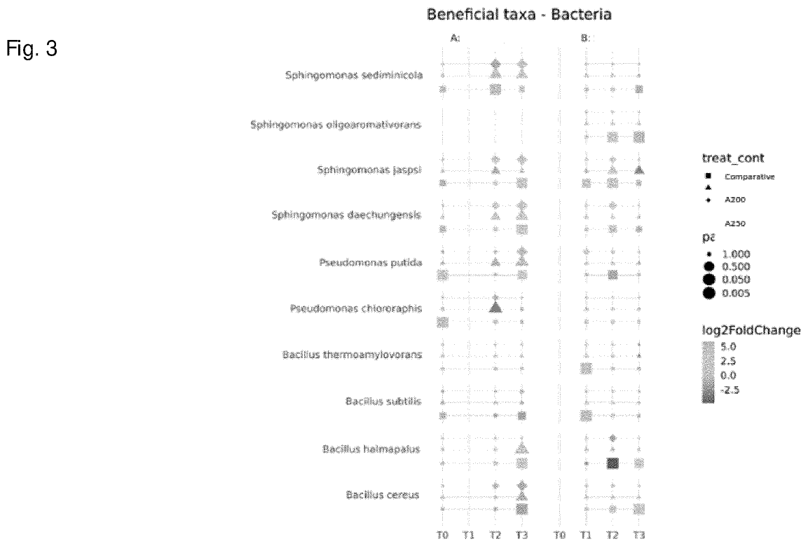

The location A plot is where the applied treatments were shown to have the greatest effect. More specifically, the treatments of cyclobutrifluram (Examples 1 and 2, A_200 and A_250) was shown to be most efficient by stimulating growth of beneficial bacterial species with biocontrol activity. These treatments induced a significant increase in Pseudomonas putida, a plant growth-promoting rhizobacterium (PGPR) that possesses genes favouring nutrient mobilization, prevention of pathogen development, and efficient niche colonization. Also, Sphingomonas species (S. sediminicola, S. japsi and S. daechungensis) tend to increase significantly for the location A in T3 (120 days after application) and for location B in T2 (60 days after application) consistently with the application of different treatments (FIG. 3). This genus of bacteria has been related widely with bioremediation and fungicide properties. The genus Bacillus has been related with several beneficial functions in the soil and for the plant's health, as phytohormone production, pathogens protection and abiotic stress protection. It was found in T2 that the abundance of Bacillus halmapalus and B. cereus increased significantly.

Also, the complete microbial species biodiversity was analysed, whereby it was observed that while microbial richness and evenness varied over time and per measurement, treatments according to the invention did not induce negative changes in any location (see FIG. 2).

### Beneficial Fungi

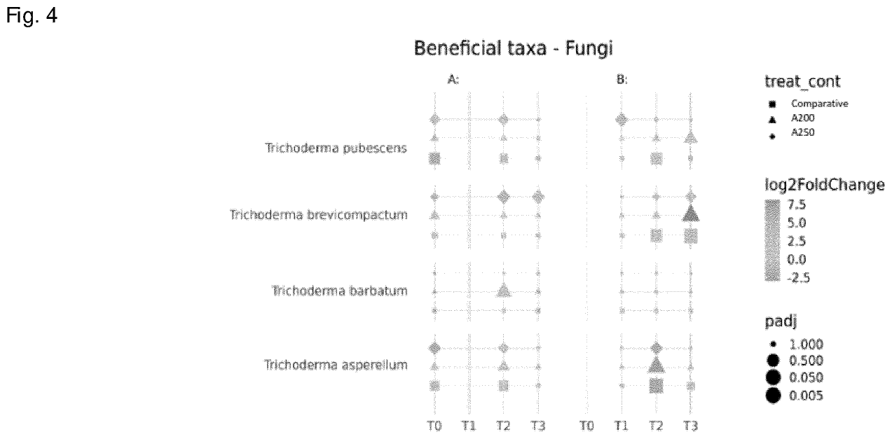

The treatments of Examples 1 and 2 in Table 3 according to the invention (A_200 and A_250) increased the Trichoderma brevicompactum relative abundance in location B (FIG. 4). Trichoderma species are a widely known group of ascomycetes which are considered to provide several benefits function, including a natural fungicide function, which provide protection to the plants to several pathogenic fungi.

Effect of Fluopyram as comparative example: The findings of the beneficial, or at least neutral effects of the use of cyclobutrifluram contrasted strongly with those of the comparative examples using fluopyram, which showed an impact in promoting in particular plant-pathogenic microbes.

### Concluding Remarks

Cyclobutrifluram treatment to counteract nematode infestation showed positive and preservative effects for soil microbiome diversity, resulting in a vibrant microbiome. Yet further, no significant negative effects of cyclobutrifluram were observed on the soil bacterial community of tomato plants in presence of RKN infestation in the medium-long term. Quite to the contrary, cyclobutrifluram treatment had a positive effect in the medium-long term on the soil fungal community of tomato plants in presence of RKN infestation. In particular, the relative abundance of the plant-pathogen Fusarium was substantially reduced by the treatment with cyclobutrifluram.

The experiments carried out in potatoes concluded that the use of cyclobutrifluram did not induce negative changes into the soil microbiome community, but rather its application induced a significant enhancement of beneficial bacteria and fungal species such as Sphingomonas sediminicola, S. japsi, S. daechungensis, Bacillus halmapalus, B. cereus, Pseudomonas putida and Trichoderma brevicompactum, which have an important role in pathogens protection, bioremediation, and plant growth-promoting rhizobacterium (PGPR). The comparative example did not show any beneficial effect.

Accordingly, compositions comprising cyclobutrifluram have shown conclusively to benefit the soil microbiome, by retaining the beneficial bacterial species diversity, and by suppressing pathogenic fungi, in particularly when compared to compositions comprising fluopyram. Hence, it is clear that Cyclobutrifluram treatment preserves soil biodiversity, and hence will preserve a vibrant range of life forms in the soil and enable plants to develop bigger root systems in infested farmlands.

Effect On and Compatibility with Arbuscular Mycorrhizal Fungi

### Selection of Active Ingredients

A group of clyclobutrifluram analogues with high nematocidal activity and varying degrees of fungicidal activity against a diverse fungal and Oomycete disease spectrum was selected, based on a toxicity screens on nematodes (species Heterodera schachtii, Meloidogyne incognita) and fungal lineages including Ascomycota classes Dothideomycetes (species Zymoseptoria tritici, Cercospora arachidicola, Pyrenophora teres, Alternaria solani, Phaeosphaeria nodorum), Leotiomycetes (Erysiphe graminis, Erysiphe graminis, Botryotinia fuckeliana, Sclerotinia sclerotiorum), Sordariomycetes (Glomerella lagenarium, Fusarium Culmorum, Fusarium Culmorum, Fusarium graminearum, Gaeumannomyces graeminis, Magnaporthe grisea, Monographella nivalis) and Basidiomycota (Thanatephorus cucumeris, Puccinia recondita) as well as the Oomycota (species Plasmopara viticola, Pythium ultimum, Phytophthora infestans). The average activity across all tests within the Nematodes, Dothideomycetes, Leotiomycetes, Sordariomycetes, Basidiomycota and Oomycota was calculated, showing that all compounds exhibited nematicidal and fungicidal activity.

### Testing of Cyclobutrifluram and Comparative Examples in Soybean

Soybeans of variety Toliman were treated with 0.15 mg ai/seed of cyclobutrifluram and analogues, and planted in 1.5 L pots of 0-3 mm sieved soil. The seeds were inoculated with Bradyrhizobium japonicum using a commercially available product for soybeans.

In a first series, for each active ingredient tested, 15 replicate pots were sowed. In each pot, 3 seeds were sowed. After germination, 2 seedling was removed from each pot to a final number of 1 plant per pot. Each pot was inoculated with a small amount of a mycorrhizal inoculant (Blend A, commercially available from Symbiom, Czech Republic). The plants were grown in a greenhouse for 81 days under the following conditions: Humidity at 45-64%, Temperature of 22° C. to 24° C., in a 16/8 hour day/night cycle. In a further test series, Soybeans seeds treated as outlined above were then planted in 1 Lpots of 0-3 mm sieved soil. For each active ingredient, 8 replicate pots were sowed, whereby in each pot, 3 seeds were sowed. After germination, 2 seedlings were removed from each pot to a final number of 1 plant per pot.

The plants were then grown in a growth chamber for 42 days with the following conditions: Temperature of 20° C. and with a 12/12 hour day/night.

After harvest, the percent mycorrhization was quantified using the methods of McGonigle et al. (T. P. McGONIGLE, M. H. MILLER and D. G. EVANS et al., “A new method which gives an objective measure of colonization of roots by vesicular-arbuscular mycorrhizal fungi”. New Phytol. Vol. 115 (3): 495-501.).

Table 1 below shows the structures of the compounds A1 to A7, as well as the impact of the different compounds on the mycorrhization in soybean roots. Surprisingly it was found that not only that cyclobutrifluram showed a higher colonization compared to the comparative compounds, but also vis-à-vis the control, while the tested analogues comparative examples, in spite of their structurally very closely relationship to cyclobutrifluram, exhibited a reduction on the level of colonization.

TABLE 1
Compounds tested for mycorrhizae compatibility; effect in soybean on the level of
mycorrhization in soybean roots.
Percent AM F Colonization Relative to Control

| Compound ID | | [%] arbuscular |
|---|---|---|
| (* and | | mycorrhizae fungi |
| enantiomers) | Structure | colonization vs. control. |
| Cyclobutrifluram* | 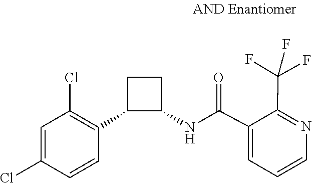 [SMILES: O=C(N[C@H]1CC[C@H]1c1ccc(Cl)cc1Cl)c1cccnc1C(F)(F)F] | 115 |
| A1 | 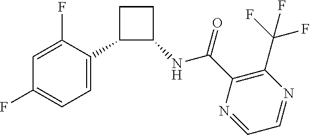 [SMILES: O=C(N[C@H]1CC[C@H]1c1ccc(F)cc1F)c1nccnc1C(F)(F)F] | 61 |
| A2 | 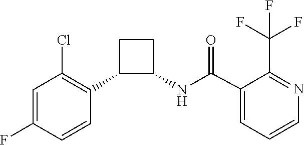 [SMILES: O=C(N[C@H]1CC[C@H]1c1ccc(F)cc1Cl)c1cccnc1C(F)(F)F] | 72 |
| A3 | 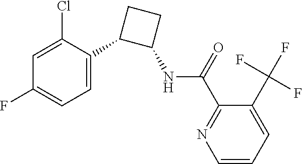 [SMILES: O=C(N[C@H]1CC[C@H]1c1ccc(F)cc1Cl)c1ncccc1C(F)(F)F] | 84 |
| A4 | 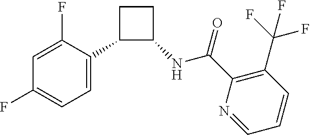 [SMILES: O=C(N[C@H]1CC[C@H]1c1ccc(F)cc1F)c1ncccc1C(F)(F)F] | 67 |
| A5* | 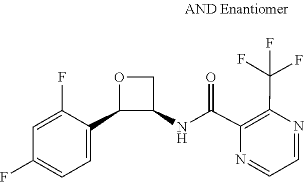 [SMILES: O=C(N[C@@H]1CO[C@@H]1c1ccc(F)cc1F)c1nccnc1C(F)(F)F] | 81 |
| A6* | 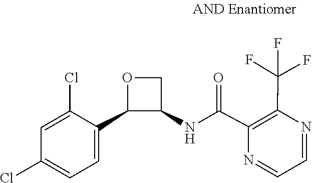 [SMILES: O=C(N[C@@H]1CO[C@@H]1c1ccc(Cl)cc1Cl)c1nccnc1C(F)(F)F] | 97 |
| A7* | 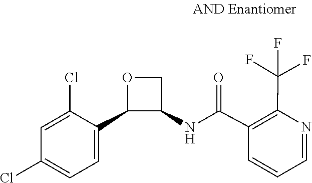 [SMILES: O=C(N[C@@H]1CO[C@@H]1c1ccc(Cl)cc1Cl)c1cccnc1C(F)(F)F] | 76 |

### Concluding Remarks

Surprisingly, Cyclobutrifluram treatment showed very positive effects on the growth of arbuscular mycorrhizal fungi for soybeans, while also substantially suppressing nematodes and undesired fungi.

The comparative examples, which employ structurally and chemically very close analogues showed a negative effect on the growth of arbuscular mycorrhizal fungi under the same conditions, in spite of the high structural similarity.

Accordingly, it has been conclusively shown that cyclobutrifluram has no negative effect on arbuscular mycorrhizal fungi, which can therefore support the growth of the plant. This also has the potential to reduce the need for fertilization. Rather, cyclobutrifluram preserves soil biodiversity, and as such will preserve a vibrant range of life forms in the soil and enable plants to develop bigger root systems in infested farmlands.

1. A method of preserving or stimulating the growth of beneficial soil microbes and/or suppressing plant-pathogenic microbes in soil for crop or plant growth, comprising applying an effective amount of a composition comprising cyclobutrifluram to the plant, the locus, or propagation material thereof.

2. The method according to claim 1, wherein stimulating growth of beneficial soil microbes comprises stimulating growth of bacterial and fungal species exhibiting biocontrol and/or soil remediation activity.

3. The method according to claim 1, wherein beneficial microbes comprise bacteria of the genus Sphingomonas, Bacillus, and/or Pseudomonas, and fungi of the genus Trichoderma.

4. The method according to claim 1, wherein beneficial microbes comprise bacteria Sphingomonas sediminicola, Sphingomonas japsi, Sphingomonas daechungensis, Bacillus halmapalus, Bacillus cereus, Pseudomonas putida and growth-promoting rhizobacterium (PGPR).

5. The method according to claim 3, wherein beneficial microbes comprise fungus Trichoderma brevicompactum.

6. The method according to claim 1, wherein the composition comprising cyclobutrifluram further comprises one or more additional biologically active agents, preferably one or more acaricide, bactericide, fungicide, insecticide, nematicide, and/or plant activator.

7. The method according to claim 1, for preserving or improving soil microbiome integrity in a soil in need of treatment, in particular, wherein the soil comprises nematode plant pests and/or plant-pathogenic fungus Fusarium.

8. The method according to claim 1, wherein the composition comprising cyclobutrifluram is applied via irrigation, soil drenching, in-furrow application, and/or as a seed treatment or inoculation wherein the soil treatment is performed with an amount in the range of between 10 grams and 500 grams cyclobutrifluram per hectare.

9. The method according to claim 1, wherein the composition comprising cyclobutrifluram is applied onto a seed or propagation material, or inoculated therein, in an amount of between 1 gram and 1000 grams cyclobutrifluram per 100 kg seeds or propagation material.

10. The method according to claim 1, wherein the application of the composition comprising cyclobutrifluram is conducted prior to planting, during, or after planting.

11. The method according to claim 1, wherein root development of plants growing in the soil is increased compared to the roots of plants growing in untreated soil.

12. Use of a composition comprising cyclobutrifluram for preserving or improving soil microbiome integrity in a soil in need of treatment.

13. Use of a composition comprising cyclobutrifluram for improving plant wellness and/or plant root growth of plants growing in a soil in need of treatment.

14. The use according to claim 13, wherein a soil in need of stimulation is selected by identifying a soil portion containing a plant pest present in an amount sufficient to harm or reduce the growth of a plant growing in the soil.

15. The use according to claim 14, wherein the plant pests include plant parasitic nematodes, in particular endoparasitic-, semi-endoparasitic- and/or ectoparasitic nematodes; and/or harmful bacteria or fungi, in particular fungi of the genus Fusarium.
